(19) United States
(12) Patent Application Publication
(10) Pub. No.: US 2025/0074093 A1
(43) Pub. Date: Mar. 6, 2025

(54) APPARATUS WITH COVER

(71) Applicant: SEIKO EPSON CORPORATION, Tokyo (JP)

(72) Inventors: Kazutoshi MATSUZAKI, SHIOJIRI-SHI (JP); Kentaro NAKAMURA, SHIOJIRI-SHI (JP); Takehiro SHIN, SHIOJIRI-SHI (JP)

(21) Appl. No.: 18/822,551

(22) Filed: Sep. 3, 2024

(30) Foreign Application Priority Data
Sep. 4, 2023 (JP) 2023-143118

(51) Int. Cl. B41J 29/13; B65H 5/00

(52) U.S. Cl. CPC B41J 29/13; B65H 5/00; B65H 2402/441; B65H 2801/06

(57) ABSTRACT

An apparatus includes a housing, a cover, and a moving unit capable of moving to a first position and a second position, the cover includes a first pressing portion configured to press the moving unit positioned at the first position, a first biasing member, a second pressing portion, and a second biasing member, when the cover is in a closed state, pressing force with which the moving unit is pressed as a result of the first pressing portion being biased by the first biasing member is the same as pressing force with which the moving unit is pressed as a result of the second pressing portion being biased by the second biasing member, and when the cover is in an open state, the second pressing portion protrudes beyond the first pressing portion.

The present application is based on, and claims priority from JP Application Serial Number 2023-143118, filed Sep. 4, 2023, the disclosure of which is hereby incorporated by reference herein in its entirety.

### BACKGROUND

### 1. Technical Field

The present disclosure relates to an apparatus with a cover such as a recording apparatus.

### 2. Related Art

An example of such an apparatus is the apparatus disclosed in JP-A-2010-244083. JP-A-2010-244083 discloses the following. A cover 10 is provided with a biasing spring 35. The biasing member 35 presses a frame 31 while the cover 10 is closed, thereby positioning a unit 200. When the cover 10 is opened, the cover 10 is pushed up by the elastic force of the spring. Thus, the cover 10 is in a half-open state.

With the structure disclosed in JP-A-2010-244083, frictional force may be generated between the cover and the apparatus when the cover is opened depending on the structure. In this case, when the frictional force overwhelms the elastic force of the spring, the opening amount of the cover becomes small. As a result, the desired opening amount may fail to be achieved.

### SUMMARY

An apparatus with a cover according to the present disclosure to solve the problem described above includes a housing, the cover configured to be opened or closed, by pivoting about a pivot shaft with respect to the housing, and a moving unit that is provided inside the housing, the moving unit being positioned at a first position when the cover is in a closed state, and being capable of moving to a second position different from the first position when the cover is in an open state, wherein the cover has a base end portion on a side closer to the pivot shaft, and a distal end portion on a side farther from the pivot shaft, and includes a first pressing portion that is provided at a position closer to the base end portion than to the distal end portion, and is configured to press the moving unit positioned at the first position, a first biasing member configured to bias the first pressing portion toward the moving unit when the cover is in the closed state, a second pressing portion that is provided at a position closer to the distal end portion than to the base end portion, and is configured to press the moving unit positioned at the first position, and a second biasing member configured to bias the second pressing portion toward the moving unit when the cover is in the closed state, when the cover is in the closed state, pressing force with which the moving unit is pressed as a result of the first pressing portion being biased by the first biasing member is the same as pressing force with which the moving unit is pressed as a result of the second pressing portion being biased by the second biasing member, and when the cover is in the open state, the second pressing portion protrudes beyond the first pressing portion.

### BRIEF DESCRIPTION OF THE DRAWINGS

FIG. 1 is an external perspective view of an apparatus with a cover according to an embodiment.

FIG. 2 is a schematic perspective view illustrating a state where the cover is open in the embodiment.

FIG. 3 is a perspective view of a lock mechanism of the embodiment.

FIG. 4 is a perspective view of the lock mechanism of the embodiment.

FIG. 5 is a perspective view of a main part of the lock mechanism of the embodiment.

FIG. 6 is a side view of a main part of a detection unit and a detected portion of the embodiment.

FIG. 7 is a side view of the main part of the detection unit and the detected portion of the embodiment.

FIG. 8 is a side view of the main part of the detection unit and the detected portion of the embodiment.

FIG. 9 is a perspective view illustrating a relationship between a moving unit and a component on the cover side of the embodiment.

FIG. 10 is a perspective view of a swing lock mechanism of the embodiment.

FIG. 11 is a side cross-sectional view of a main part illustrating an operation of the moving unit and the swing lock mechanism of the embodiment.

FIG. 12 is a side cross-sectional view of a main part illustrating an operation of the moving unit and the swing lock mechanism of the embodiment.

FIG. 13 is a side cross-sectional view of a main part illustrating an operation of the moving unit and the swing lock mechanism of the embodiment.

FIG. 14 is a perspective view of a main part of a first pressing portion of the embodiment.

FIG. 15 is a perspective view of a main part of the first pressing portion of the embodiment.

FIG. 16 is a perspective view of a main part of a second pressing portion of the embodiment.

FIG. 17 is a perspective view of a main part of the second pressing portion of the embodiment.

FIG. 18 is a schematic plan view illustrating a state where the cover is open in the embodiment.

FIG. 19 is a perspective cross-sectional view of a main part of the first pressing portion of the embodiment.

FIG. 20 is a cross-sectional view of a main part of the first pressing portion of the embodiment.

FIG. 21 is a cross-sectional view of a main part of the second pressing portion of the embodiment.

### DESCRIPTION OF EMBODIMENTS

The present disclosure will first be schematically described below.

An apparatus with a cover according to a first aspect of the present disclosure to solve the problem described above includes a housing, the cover configured to be opened or closed, by pivoting about a pivot shaft with respect to the housing, and a moving unit that is provided inside the housing, the moving unit being positioned at a first position when the cover is in a closed state, and being capable of moving to a second position different from the first position when the cover is in an open state, wherein the cover has a base end portion on a side closer to the pivot shaft, and a distal end portion on a side farther from the pivot shaft, and includes a first pressing portion that is provided at a position closer to the base end portion than to the distal end portion, and is configured to press the moving unit positioned at the first position, a first biasing member configured to bias the first pressing portion toward the moving unit when the cover is in the closed state, a second pressing portion that is provided at a position closer to the distal end portion than to the base end portion, and is configured to press the moving unit positioned at the first position, and a second biasing member configured to bias the second pressing portion toward the moving unit when the cover is in the closed state, when the cover is in the closed state, pressing force with which the moving unit is pressed as a result of the first pressing portion being biased by the first biasing member is the same as pressing force with which the moving unit is pressed as a result of the second pressing portion being biased by the second biasing member, and when the cover is in the open state, the second pressing portion protrudes beyond the first pressing portion.

Here, “bias” is used to mean applying elastic force to a target object by using elastic force provided by an elastic body such as a spring or rubber.

In addition, “same” in “pressing force . . . is the same” does not need to be the same in a strict sense, and is used to mean the same in such a range that satisfies the specifications of the posture to be taken by the moving unit with the pressing force acting on the moving unit.

According to the present aspect, when the cover is in the open state, the second pressing portion protrudes beyond the first pressing portion. In other words, when the cover pivots about the pivot shaft serving as a fulcrum to transition from the closed state to the open state, the second pressing portion positioned on the distal end portion side of the cover protrudes beyond the first pressing portion positioned on the base end portion side of the cover. Accordingly, when the cover is opened, an opening amount of the cover can be secured. At the same time, when the cover is closed, the first pressing portion can be reliably pushed in.

When the cover is in the closed state, the pressing force with which the moving unit is pressed as a result of the first pressing portion being biased by the first biasing member is the same as the pressing force with which the moving unit is pressed as a result of the second pressing portion being biased by the second biasing member. Accordingly, when the cover is closed, both sides of the moving unit can be pressed with the same pressing forces by the first pressing portion and by the second pressing portion. That is, the first pressing portion and the second pressing portion can uniformly press the moving unit at two places on a side closer to and a side farther from the pivot shaft.

An apparatus with a cover according to a second aspect of the present disclosure is an aspect depending on the first aspect, and further includes a first holder configured to hold the first pressing portion and the first biasing member, a second holder configured to hold the second pressing portion and the second biasing member, a first restricting portion provided to the first holder, a second restricting portion provided to the second holder, a first restricted portion provided to the first pressing portion, and a second restricted portion provided to the second pressing portion, wherein when the first restricted portion comes into contact with the first restricting portion while the cover is in the open state, movement of the first pressing portion in a protruding direction is restricted, when the second restricted portion comes into contact with the second restricting portion while the cover is in the open state, movement of the second pressing portion in the protruding direction is restricted, a length from the first restricted portion to a distal end of the first pressing portion and a length from the second restricted portion to a distal end of the second pressing portion are the same, and the second restricting portion is positioned downstream of the first restricting portion in the protruding direction.

Here, “same” in “lengths are the same” does not require that both lengths are exactly the same, and is used to mean that it suffices if the lengths are the same within a range in which the advantageous effects can be achieved.

According to the present aspect, the length from the first restricted portion provided to the first pressing portion to the distal end of the first pressing portion is the same as the length from the second restricted portion provided to the second pressing portion to the distal end of the second pressing portion. Further, the second restricting portion provided to the second holder is positioned downstream of the first restricting portion provided to the first holder in the protruding direction. With this configuration, “the pressing force of the first pressing portion and the pressing force of the second pressing portion are the same” and “when the cover is in the open state, the second pressing portion protrudes beyond the first pressing portion” in the first aspect can be easily achieved with a simple structure. Therefore, the same effects as those with the first aspect can be achieved.

In addition, by changing the position of the first restricting portion, it is possible to easily adjust the amount of protrusion of the first pressing portion from the first holder. Similarly, by changing the position of the second restricting portion, it is possible to easily adjust the amount of protrusion of the second pressing portion from the second holder.

An apparatus with a cover according to a third aspect of the present disclosure is an aspect depending on the second aspect, wherein the first pressing portion and the second pressing portion are configured by the same components, and the first biasing member and the second biasing member are configured by the same components.

Here, “the same components” mean not only components having the same structure as viewed from the front, rear, upper, lower, left, and right sides, but also components having a symmetrical relationship with respect to one surface.

According to the present aspect, the first pressing portion and the second pressing portion are configured by the same components, and the first biasing member and the second biasing member are configured by the same components. The common use of the components facilitates the manufacture and reduces the cost.

An apparatus with a cover according to a fourth aspect of the present disclosure is an aspect depending on any one of the first aspect to the third aspect, and further includes a positioning pin configured to position the cover, and an insertion opening into which the positioning pin is inserted when the cover is in the closed state.

Here, the positioning pin may be provided to either the cover or the housing. The insertion opening is provided to one of the cover and the housing to which the positioning pin is not provided.

When the apparatus with the cover is a structure using the positioning pin, frictional force may be generated between the cover and the insertion opening when the cover is opened. According to the present aspect, even in such a structure, the cover can be reliably opened.

An apparatus with a cover according to a fifth aspect of the present disclosure is an aspect depending on the fourth aspect, wherein the positioning pin and the insertion opening are provided at opposite positions with respect to the pivot shaft.

In a structure in which the positioning pin and the insertion opening are at opposite positions with respect to the pivot shaft, the distal end portion side (free end side) of the cover tends to sag due to its own weight. In such a structure, in a state where the positioning pin is inserted into the insertion opening and positioned, about half of the weight of the cover is applied to the positioning pin. Thus, frictional force is particularly likely to be generated between the positioning pin and the insertion opening. According to the present aspect, even in such a structure, the cover can be reliably opened.

An apparatus with a cover according to a sixth aspect of the present disclosure is an aspect depending on any one of the first aspect to the third aspect, and further includes a lock mechanism configured to lock the pivoting of the cover from the closed state to the open state, wherein the lock mechanism includes an engaged portion provided to the housing, an engaging portion provided to the cover, and an operation portion provided to the cover, transition is achievable through an operation on the operation portion, between a locked state in which the pivoting of the cover is locked as a result of engagement between the engaging portion and the engaged portion, and an unlocked state in which the engagement between the engaging portion and the engaged portion is released, and when the unlocked state is achieved, the cover pivots from the closed state to the open state, as a result of protrusion of the first pressing portion and the second pressing portion.

According to the present aspect, when the lock mechanism is in the unlocked state, the first pressing portion and the second pressing portion are biased by the first biasing member and the second biasing member, respectively, and thus protrude. By the protrusion, the cover pivots from the closed state to the open state. As a result, the cover is automatically opened when the unlocked state is achieved, and thus the operability for the user can be improved.

An apparatus with a cover according to a seventh aspect of the present disclosure is an aspect depending on the fifth aspect, and further includes a detected member provided to the cover, and a detection unit configured to detect the detected member to detect opening and closing of the cover, wherein an amount of protrusion of the second pressing portion is set to make the cover pivot until the detected member reaches a position not to be detected by the detection unit when the unlocked state is achieved.

According to the present aspect, the amount of protrusion of the second pressing portion is set to make the cover pivot until the detected member reaches a position not to be detected by the detection unit when the unlocked state is achieved. With this configuration, when the unlocked state is achieved, the cover overcomes the frictional force between the positioning pin and the insertion opening to open, and the open state can be sensed by the detection unit.

An apparatus with a cover according to an eighth aspect of the present disclosure is an aspect depending on the first aspect, and further includes a recording unit configured to perform recording on a medium, and a conveyance unit configured to convey the medium, wherein the moving unit is the conveyance unit, and the conveyance unit positioned at the first position faces the recording unit. In other words, the apparatus with the cover according to the present aspect is a recording apparatus including the recording unit and the conveyance unit serving as the moving unit.

Note that the present aspect may also depend on any one of the second to seventh aspects.

According to the present aspect, it is possible to both stabilize an interval between the recording unit and the conveyance unit when the cover is in the closed state and secure the opening amount of the cover when the unlocked state is achieved.

### Embodiments

Embodiments of an apparatus with a cover according to the present disclosure will be specifically described below based on the drawings.

In the following description, three axes that are perpendicular to each other will be referred to as an X axis, a Y axis, and a Z axis as illustrated in each figure. Directions indicated by arrows of the three axes (X, Y, and Z) are +directions of the respective directions, and opposite directions are −directions. The Z axis direction corresponds to a vertical direction, that is, a direction in which gravity acts, the +Z direction indicates a vertically upward direction, and the −Z direction indicates a vertically downward direction. The X axis direction and the Y axis direction correspond to horizontal directions. The +Y direction indicates a forward direction of the apparatus, and the −Y direction indicates a rearward direction of the apparatus. The +X direction indicates a rightward direction of the apparatus, and the −X direction indicates a leftward direction of the apparatus.

Apparatus with Cover, and Recording Apparatus

In the present embodiment, an apparatus 1 with a cover is described as a recording apparatus 100 such as an ink jet printer.

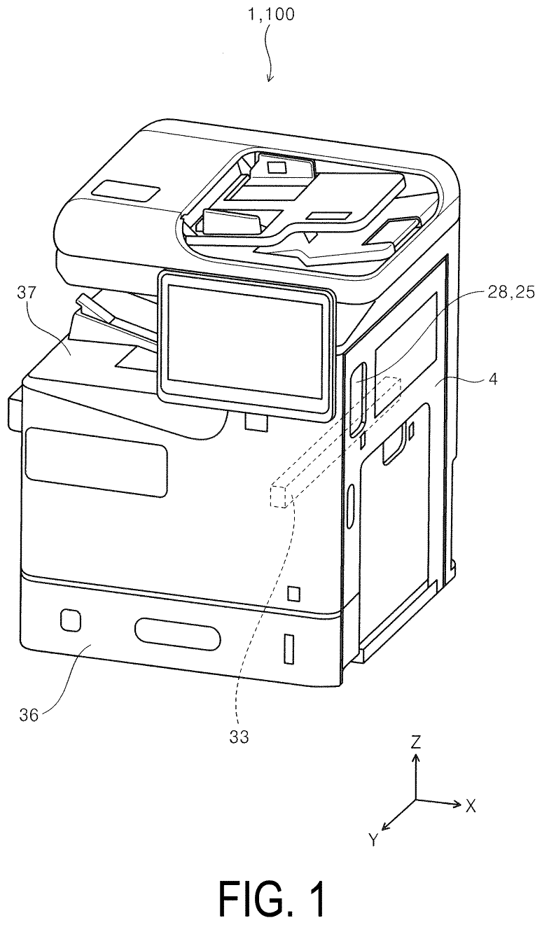

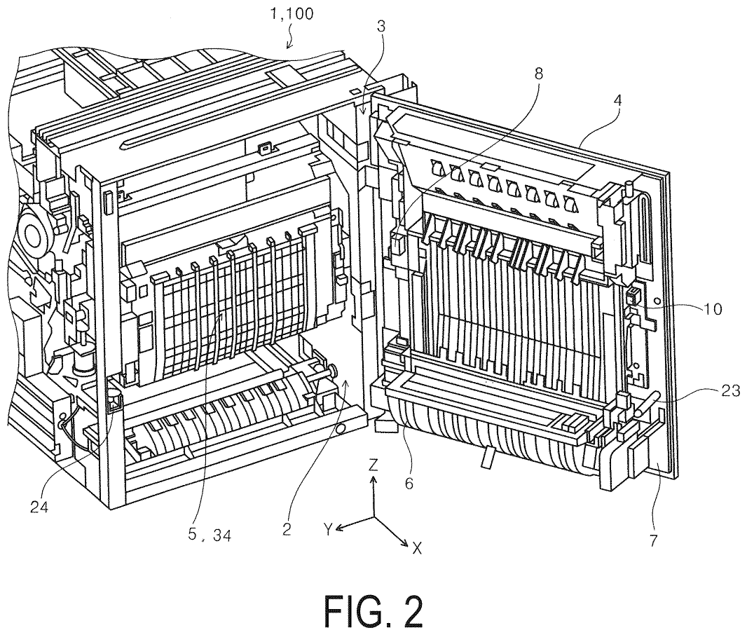

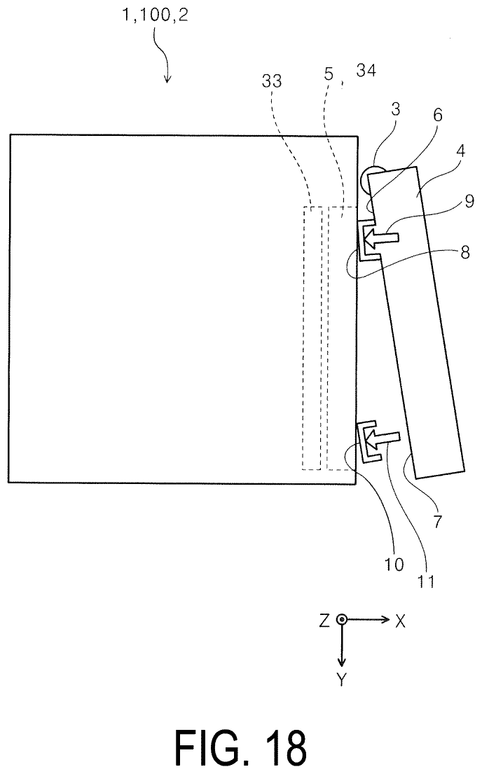

As illustrated in FIG. 1, the apparatus 1 with a cover, which is the recording apparatus 100, includes a cover 4 that can be opened and closed with respect to a housing 2 (FIG. 2), a recording unit 33 (FIGS. 1 and 18) that is provided in the housing 2 and performs recording on a medium such as paper, a medium conveyance device including a conveyance unit 34 that conveys a medium stored in a medium storage unit 36 along a conveyance path, and a discharge tray 37 to which the medium after the recording by the recording unit 33 is discharged.

Here, the conveyance unit 34 faces the recording unit 33, and is a moving unit 5 described below. The conveyance unit 34 is designed to be at a constant distance to the recording unit 33, in order to ensure recording accuracy on the medium. Furthermore, the conveyance unit 34 is configured to be able to swing in a direction in which an upper portion moves away from the recording unit 33 with a lower portion serving as a fulcrum, so that when the medium is jammed in the conveyance path in a region of the recording unit 33, the medium can be removed.

The recording operation on the medium at the recording unit 33, the conveyance operation for the medium at the medium conveyance device, and the like are performed by a control unit (not illustrated). Here, the control unit includes a CPU, a flash ROM, and a RAM. The CPU performs various arithmetic processing in accordance with a program stored in the flash ROM, and controls the entire operation of the recording apparatus 100. The flash ROM serving as an example of a storage unit is a readable and rewritable nonvolatile memory. The RAM serving as an example of a storage unit temporarily stores a variety of information.

### Cover Lock Mechanism

As illustrated in FIGS. 2 to 8 and 18, in the present embodiment, the cover 4 is opened and closed by being pivoting with respect to the housing 2 about a pivot shaft 3. A lock mechanism 25 is provided to lock the pivoting of the cover 4 from a closed state (FIG. 1) to an open state (FIG. 2).

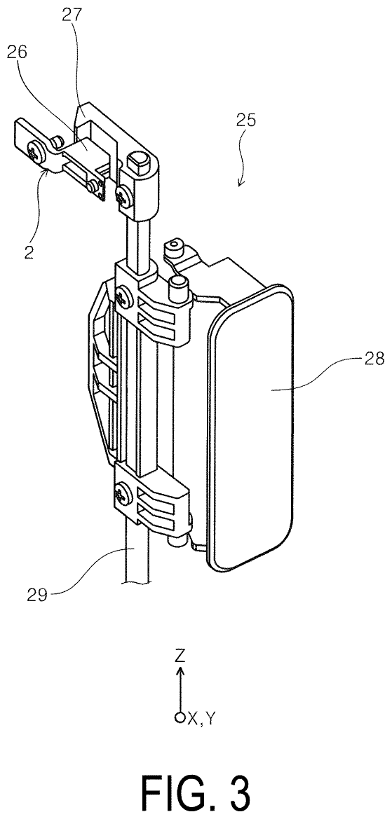

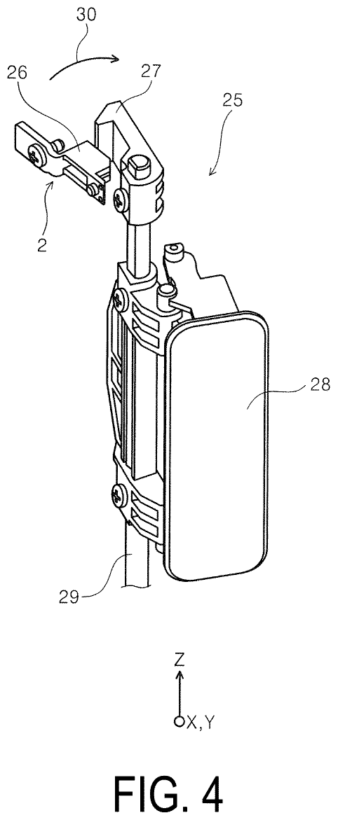

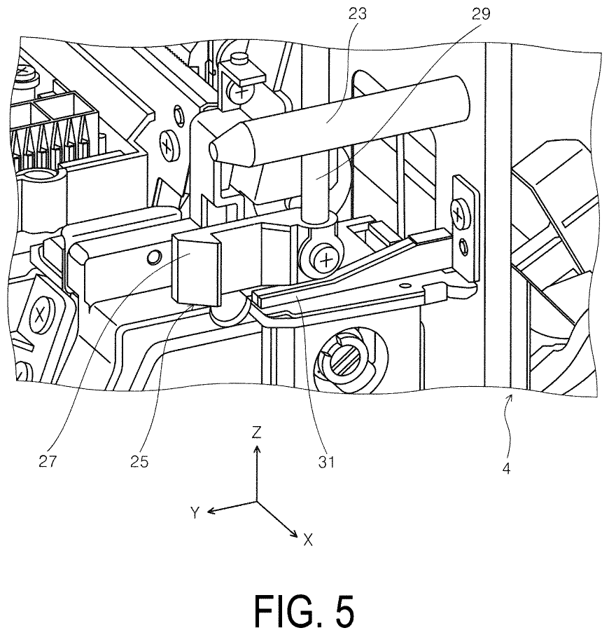

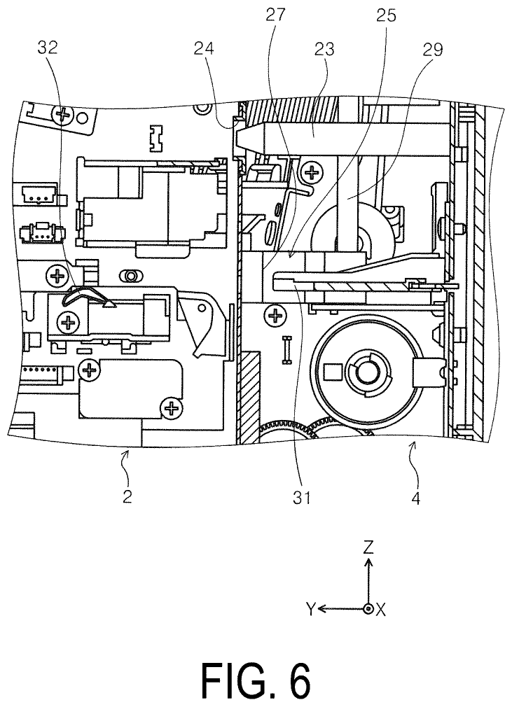

Specifically, as illustrated in FIGS. 3 and 4, the lock mechanism 25 includes an engaged portion 26 provided to the housing 2, an engaging portion 27 (FIGS. 5 and 6) provided to the cover 4, and an operation portion 28 (FIGS. 1 and 2) provided to the cover 4.

As illustrated in FIG. 3, the engaged portion 26 is fixed to a frame (not illustrated) of the housing 2. The engaging portion 27 is attached to a shaft 29 so as to rotate integrally with the shaft 29. As illustrated in FIGS. 5 and 6, the shaft 29 is attached a frame (not illustrated) of the cover 4 so as to be rotatable about the axis, i.e. about the Z axis. The engaging portion 27 is attached to each of an upper end portion and a lower end portion of the shaft 29. FIGS. 3 and 4 illustrate the upper end portion of the shaft 29. The operation portion 28 is attached to the upper end portion of the shaft 29. When the user operates the operation portion 28 illustrated in FIG. 1 in a pushing manner, the shaft 29 rotates about the axis. When the shaft 29 rotates about the axis, the engaging portion 27 pivots from the position illustrated in FIG. 3 in a direction indicated by an arrow 30 illustrated in FIG. 4. FIG. 3 illustrates a locked state in which the engaging portion 27 is engaged with the engaged portion 26 to be locked. FIG. 4 illustrates an unlocked state in which the engagement of the engaging portion 27 with the engaged portion 26 is released.

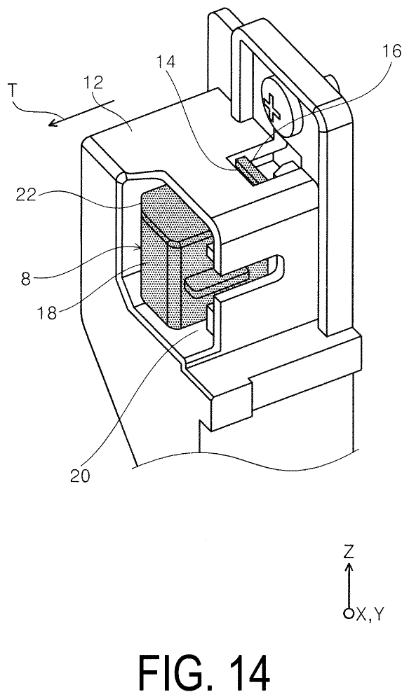

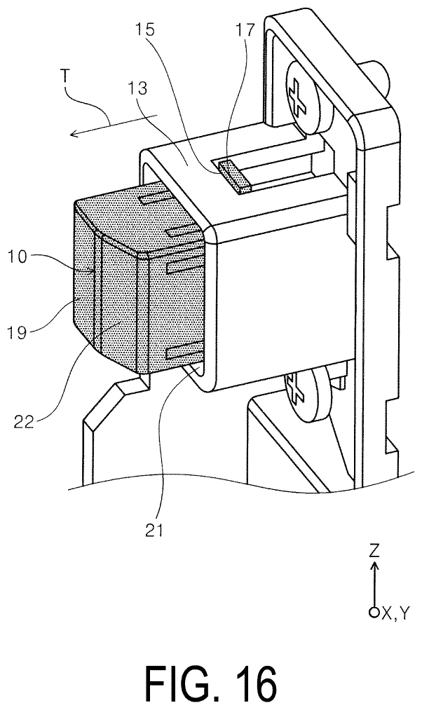

Specifically, through the operation on the operation portion 28, the lock mechanism 25 can transition between the locked state (FIG. 3) in which the pivoting of the cover 4 is locked as a result of the engagement between the engaging portion 27 and the engaged portion 26 and the unlocked state (FIG. 4) in which the engagement between the engaging portion 27 and the engaged portion 26 is released. In the unlocked state, a first pressing portion 8 (FIG. 14) and a second pressing portion 10 (FIG. 16), which will be described later, protrude, to make the cover 4 pivot from the closed state to the open state.

### Positioning Pin and Insertion Opening

As illustrated in FIGS. 2 and 5 to 8, in the present embodiment, a positioning pin 23 for positioning the cover 4 and an insertion opening 24 into which the positioning pin 23 is inserted when the cover 4 is in the closed state are provided. Here, the positioning pin 23 is provided to the cover 4, and the insertion opening 24 is provided to the housing 2. The positioning pin 23 may be provided to the housing 2, and the insertion opening 24 may be provided to the cover 4. The positioning pin 23 and the insertion opening 24 are provided for positioning the cover 4 with respect to the housing 2, when the cover 4 pivots from the open state to be in the closed state.

Here, the positioning pin 23 is a cylindrical body having a distal end in a truncated conical shape. The insertion opening 24 has a circular hole shape corresponding to the shape of the positioning pin 23 that is the cylindrical body. The inner diameter of the insertion opening 24 and the outer diameter of the positioning pin 23 are set to be of the same dimension within a range in which the positioning effect can be obtained.

The positioning pin 23 and the insertion opening 24 are provided at opposite positions with respect to the pivot shaft 3. Here, as illustrated in FIG. 2, the positioning pin 23 is provided in an inner side lower portion of a distal end portion 7 of the cover 4. The insertion opening 24 is provided at a position corresponding to the positioning pin 23 of the housing 2, that is, at a position corresponding to the distal end portion 7 of the cover 4.

### Detection of Open/Closed State of Cover

As illustrated in FIGS. 6 to 8, in the present embodiment, a detected member 31 provided to the cover 4 and a detection unit 32 that detects the opening and closing of the cover 4 by detecting the detected member 31 are provided. The detected member 31 is provided below and near the positioning pin 23 and at a height position to overlap the engaging portion 27 in the Z axis direction (FIGS. 5 and 6).

FIG. 6 illustrates a state immediately before the positioning pin 23 of the cover 4 enters the insertion opening 24 of the housing 2. The detected member 31 is positioned at a position away from the detection unit 32.

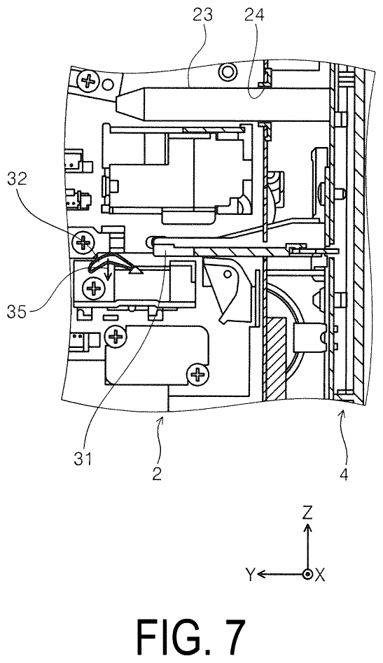

FIG. 7 illustrates a state in which the cover 4 is further pivoted and the positioning pin 23 is inserted into the insertion opening 24. The detected member 31 is still in a state of being separated from the detection unit 32. An arrow 35 in FIG. 7 indicates that the detection unit 32 swings.

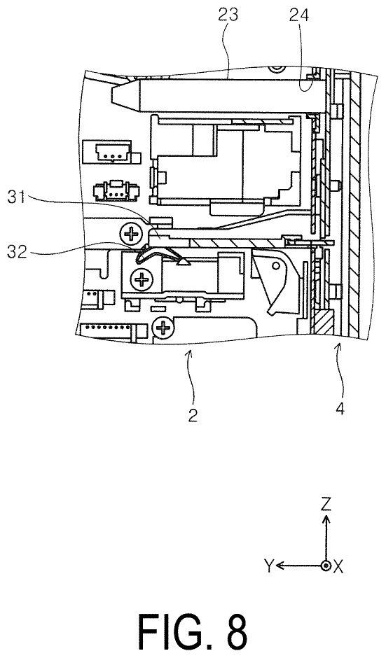

FIG. 8 illustrates the cover 4 in the closed state (FIG. 1) as a result of being further pivoted. The detected member 31 is positioned at a position to be detected by the detection unit 32. The detection unit 32 is in a state of being pushed by the detected member 31 from above, to swing in a direction indicted by the arrow 35 (FIG. 7). In this state, the detection unit 32 detects that the cover 4 is in the closed state and transmits the detection result to the control unit. The apparatus 1 with a cover recognizes that the cover 4 is in the closed state. In this closed state, the lock mechanism 25 is in the locked state.

When the operation portion 28 is operated to change the lock mechanism 25 from the locked state to the unlocked state, the first pressing portion 8 (FIG. 14) and the second pressing portion 10 (FIG. 16), which will be described later, protrude, to make the cover 4 pivot from the closed state to the open state.

Specifically, the state illustrated in FIG. 8 is changed to the state illustrated in FIG. 7. Thus, the detected portion 31 is separated from the position to be detected by the detection unit 32. As a result, the detection unit 32 detects that the cover 4 has changed from the closed state to the open state, and transmits the detection result to the control unit. The apparatus 1 with a cover receives the detection result and recognizes that the cover 4 is in the open state.

First Pressing Portion, Second Pressing Portion, Moving Unit

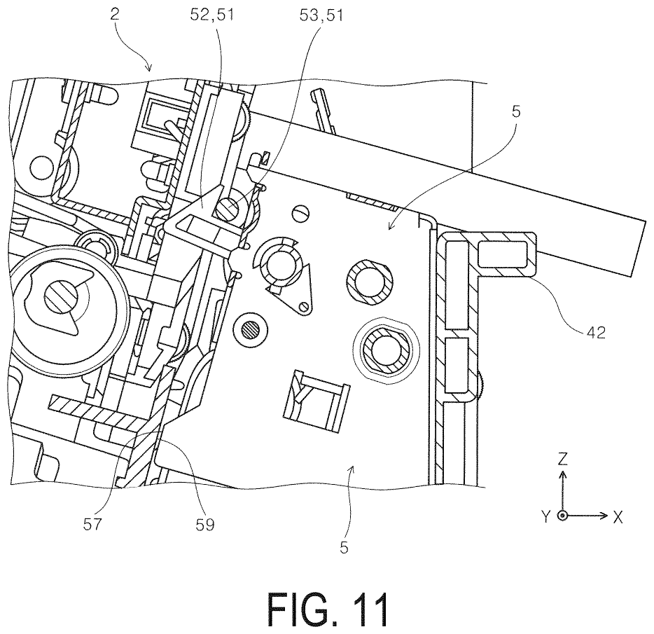

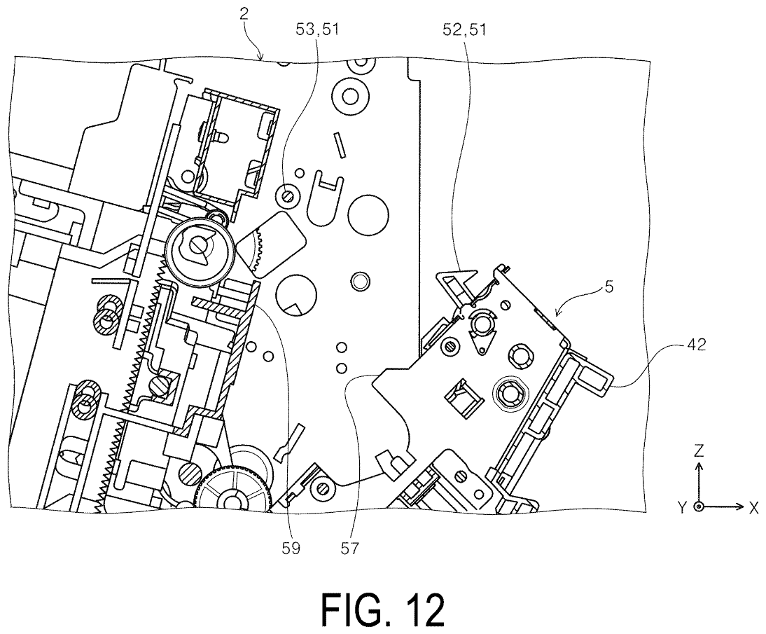

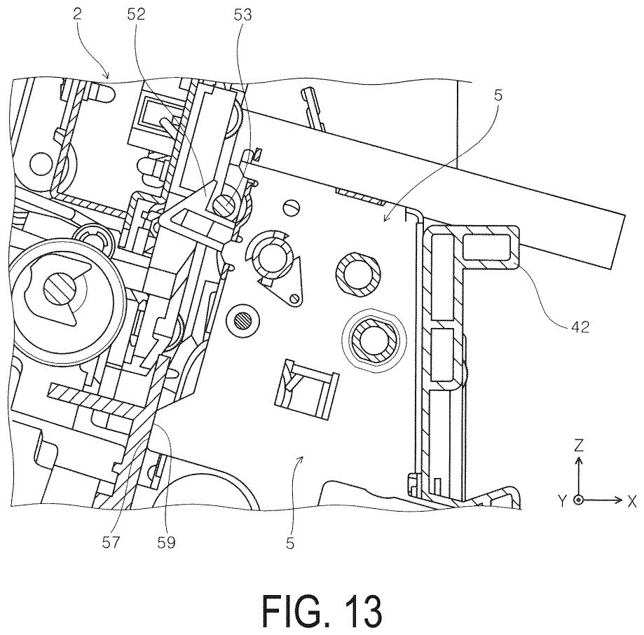

As illustrated in FIGS. 2 and 14 to 21, the apparatus 1 with a cover according to the present embodiment includes the housing 2, the cover 4, which is opened and closed by pivoting with respect to the housing 2 about the pivot shaft 3, and the moving unit 5 provided inside the housing 2. As described above, in the present embodiment, the moving unit 5 is the conveyance unit 34 positioned at a position facing the recording unit 33, and the upper portion thereof is swingable about the lower portion serving as the fulcrum. Thus, the moving unit 5 is positioned at a first position (FIG. 13) when the cover 4 is in the closed state, and is movable to be at a second position (FIGS. 11 and 12) different from the first position when the cover 4 is in the open state.

The cover 4 includes the first pressing portion 8 and a first biasing member 9. The first pressing portion 8 is provided at a position closer to a base end portion 6 defined to be on the side of the cover 4 closer to the pivot shaft 3 than to the distal end portion 7 defined to be on the side farther from the pivot shaft 3, and presses the moving unit 5 positioned at the first position (FIG. 13) toward the recording unit 33. The first biasing member 9 biases the first pressing portion 8 toward the moving unit 5, when the cover 4 is in the closed state. Here, “bias” is used to mean applying elastic force to the first pressing portion 8 as the target object by using elastic force provided by an elastic body such as a spring or rubber. Here, a coil spring is used as the first biasing member 9.

The cover 4 further includes the second pressing portion 10 and a second biasing member 11. The second pressing portion 10 is provided at a position closer to the distal end portion 7 than to the base end portion 6 of the cover 4, and presses the moving unit 5 positioned at the first position (FIG. 13) toward the recording unit 33. The second biasing member 11 biases the second pressing portion 10 toward the moving unit 5 when the cover 4 in the closed state. Here, the meaning of “bias” is the same as that described above.

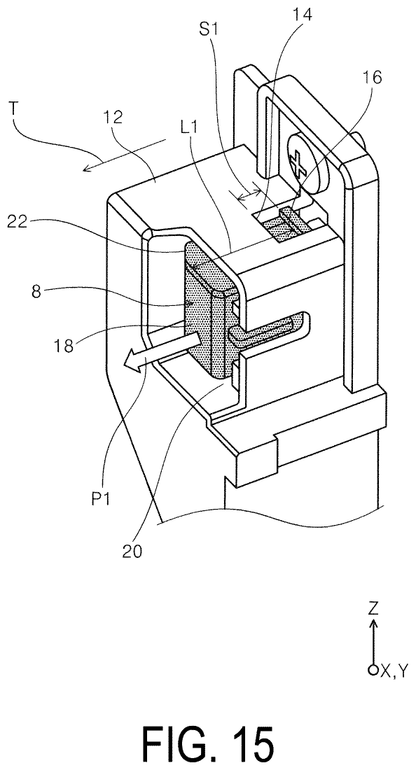

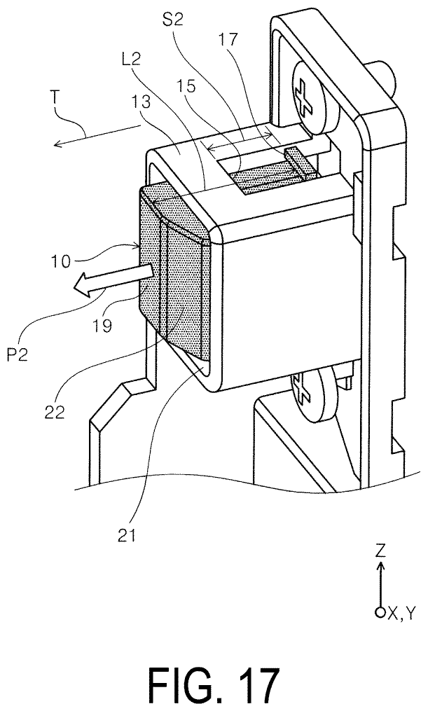

Further, when the cover 4 is in the closed state (FIG. 1), pressing force P1 (FIG. 15) with which the moving unit 5 is pressed as a result of the first pressing portion 8 being biased by the first biasing member 9 is the same as pressing force P2 (FIG. 17) with which the moving unit 5 is pressed as a result of the second pressing portion 10 being biased by the second biasing member 11. Further, when the cover 4 is in the open state, the second pressing portion 10 protrudes beyond the first pressing portion 8. The pressing forces P1 and P2 being the “same” do not need to be the same in a strict sense, and are used to mean the same in such a range that satisfies the specifications of the posture to be taken by the moving unit 5 with the pressing forces P1 and P2 acting on the moving unit 5.

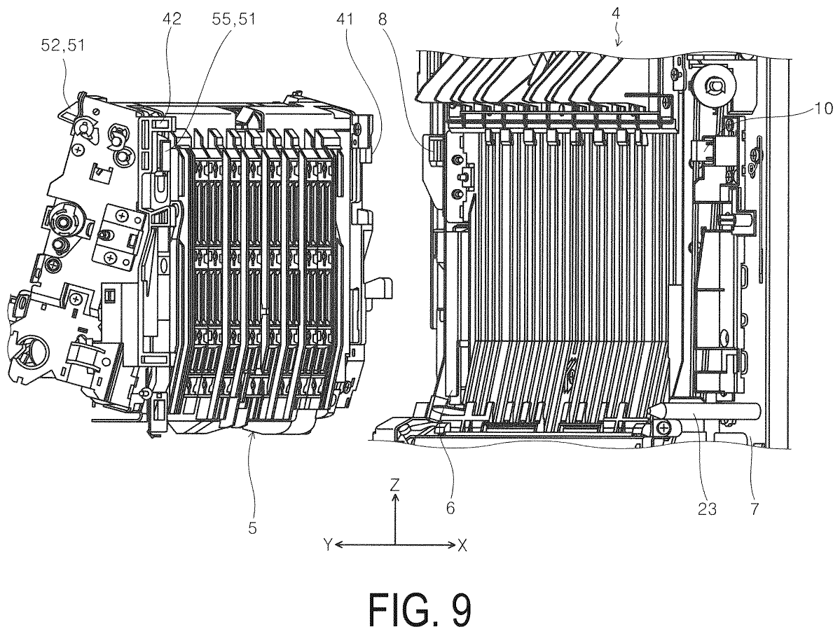

As illustrated in FIGS. 9 and 19 to 21, the moving unit 5 is provided with a pressed portion 41 that comes into contact with a distal end 18 of the first pressing portion 8 to receive the pressing force P1, when the cover 4 transitions from the open state to the closed state. Further, the moving unit 5 is provided with a pressed portion 42 that comes into contact with a distal end 19 of the second pressing portion 10 to receive the pressing force P2.

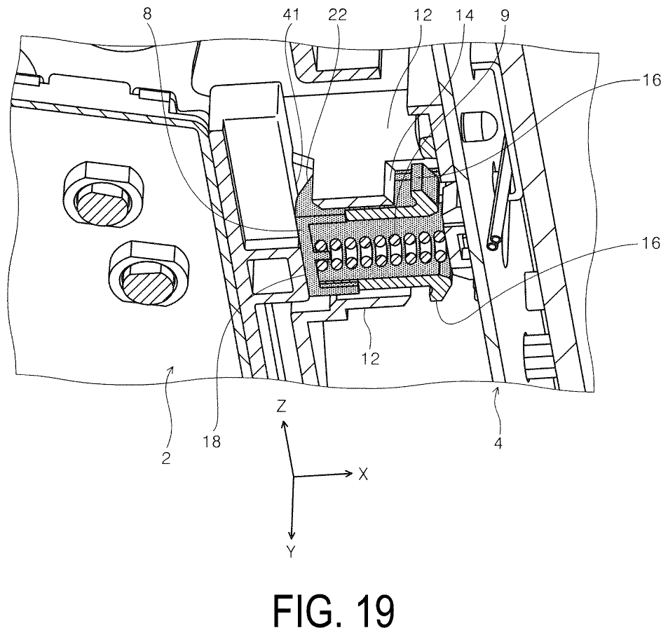

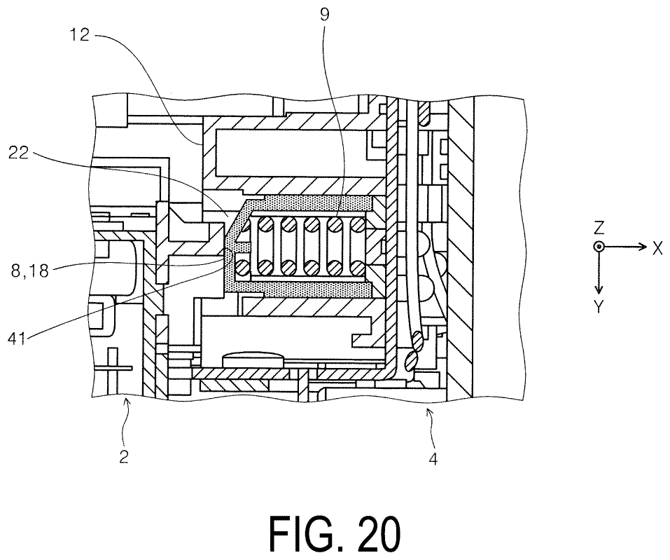

As illustrated in FIGS. 19 and 20, the distal end 18 of the first pressing portion 8 and the pressed portion 41 are formed so as to be able to come into contact with each other in a compact manner, when the cover 4 reaches the closed state by pivoting about the pivot shaft 3 serving as a pivot fulcrum. A chamfered portion 22 is formed at the distal end 18 as a specific structure for enabling the distal end 18 to come into contact with the pressed portion 41 in a compact manner.

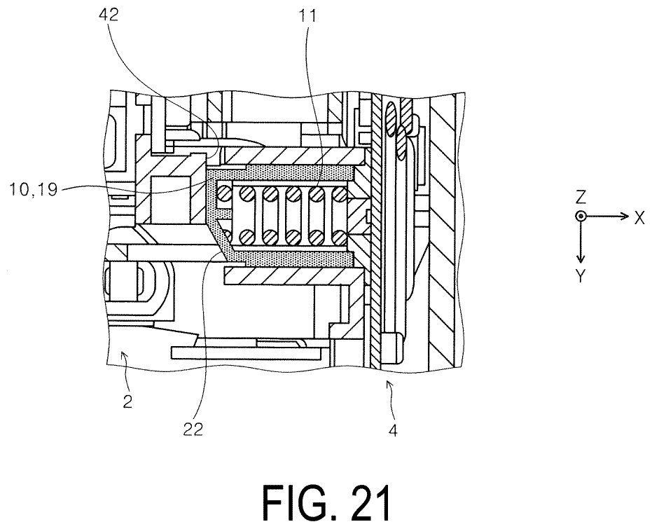

As illustrated in FIG. 21, the distal end 19 of the second pressing portion 10 and the pressed portion 42 are formed so as to be able to come into contact with each other in a compact manner, when the cover 4 reaches the closed state by pivoting about the pivot shaft 3 serving as a pivot fulcrum. While the chamfered portion 22 is formed at the distal end 19, the chamfered portion 22 may not be provided.

In the present embodiment, the apparatus 1 with a cover includes a first holder 12 and a second holder 13. The first pressing portion 8 and the first biasing member 9 are held in an interior 20 of the first holder 12. The second pressing portion 10 and the second biasing member 11 are held in an interior 21 of the second holder 13. The first holder 12 is provided with a first restricting portion 14, and the second holder 13 is provided with a second restricting portion 15. The first pressing portion 8 is provided with a first restricted portion 16, and the second pressing portion 10 is provided with a second restricted portion 17.

As illustrated in FIG. 14, when the cover 4 is in the open state, the first restricted portion 16 comes into contact with the first restricting portion 14 to restrict the movement of the first pressing portion 8 in a protruding direction T. Similarly, when the cover 4 is in the open state, as illustrated in FIG. 16, the second restricted portion 17 comes into contact with the second restricting portion 15 to restrict the movement of the second pressing portion 10 in the protruding direction T.

A length L1 from the first restricted portion 16 to the distal end 18 of the first pressing portion 8 illustrated in FIG. 15 is the same as a length L2 from the second restricted portion 17 to the distal end 19 of the second pressing portion 10 illustrated in FIG. 17. Thus, L1=L2 holds. Here, “same” in “lengths are the same” does not require that the length L1 and the length L2 are exactly the same, and it suffices if the lengths are the same within a range in which the advantageous effects can be achieved.

Further, as illustrated in FIGS. 15 and 17, the second restricting portion 15 is positioned downstream of the first restricting portion 14 in the protruding direction T. In FIG. 15, reference sign S1 indicates a distance from a position where the first pressing portion 8 is pushed back by pressing the moving unit 5 to the first restricting portion 14. In FIG. 17, reference sign S2 indicates a distance from a position where the second pressing portion 10 is pushed back by pressing the moving unit 5 to the second restricting portion 15. As illustrated in the figure, S1<S2 holds. Thus, in the present embodiment, with the relationship S1<S2 holding, a structure is achieved in which the second restricting portion 15 (FIG. 17) is positioned downstream of the first restricting portion 14 (FIG. 15) in the protruding direction T.

In addition, by changing the position of the first restricting portion 14, it is possible to easily adjust the amount of protrusion of the first pressing portion 8 from the first holder 12. Similarly, by changing the position of the second restricting portion 15, it is possible to easily adjust the amount of protrusion of the second pressing portion 10 from the second holder 13. In the present embodiment, the amount of protrusion of the second pressing portion 10 from the second holder 13 is set to make the cover 4, when the unlocked state is achieved, pivot until the detected member 31 reaches a position (FIG. 4) not to be detected by the detection unit 32.

FIGS. 15 and 17 illustrate a state in which the first pressing portion 8 and the second pressing portion 10 are pressing the moving unit 5 to apply the pressing forces P1 and P2 of the same magnitude.

In other words, the first pressing portion 8 and the second pressing portion 10 are pushed back by the reaction force from the moving unit 5. By being pushed back, the first biasing member 9 and the second biasing member 11 provide elastic forces of the same magnitude, whereby the pressing forces P1 and P2 of the same magnitude can be provided.

In the present embodiment, the first pressing portion 8 and the second pressing portion 10 are configured by the same components. Further, the first biasing member 9 and the second biasing member 11 are also configured by the same components. Here, “the same components” mean not only components having the same structure as viewed from the front, rear, upper, lower, left, and right sides, but also components having a symmetrical relationship with respect to one surface. In the present embodiment, as illustrated in FIGS. 14 and 20 and FIGS. 15 and 21, the first pressing portion 8 and the second pressing portion 10 are the same components in the symmetrical relationship.

The first biasing member 9 and the second biasing member 11 are exactly the same components. Accordingly, the pressing forces P1 and P2 can be easily set to be the same.

### Swing Lock Mechanism for Moving Unit

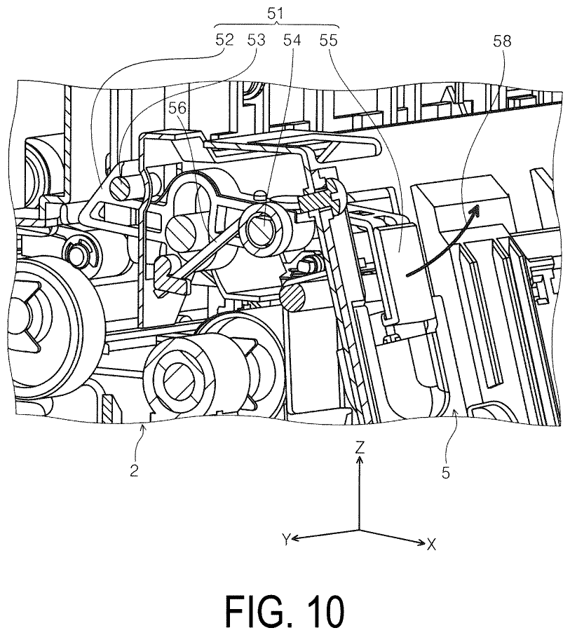

As illustrated in FIG. 10, the moving unit 5 includes a swing lock mechanism 51. In the swing lock mechanism 51, as illustrated in FIGS. 10 and 11, a locking claw 52 of the moving unit 5 is locked to a locked portion 53 on the housing 2 to prevent the swinging in the swing locked state. The swing lock mechanism 51 is configured such that when the user operates an operation portion 55 in a direction indicated by an arrow 58, the locking claw 52 swings about a shaft 54 serving as a fulcrum against the spring force of a torsion coil spring 56 to be disengaged from the locked portion 53.

FIG. 12 illustrates a swing unlocked state in which the swing locked state of the swing lock mechanism 51 is released. The upper portion of the moving unit 5 swings with the lower portion serving as the fulcrum, to achieve a state of being retracted from the position facing the recording unit 33. As a result, when the medium is jammed in the conveyance path in the region of the recording unit 33, the medium can be removed.

FIG. 11 illustrates a state in which the cover 4 is in the open state and the swing lock mechanism 51 is in the locked state. When the cover 4 is in the open state, the pressing forces P1 and P2 of the first pressing portion 8 and the second pressing portion 10 do not act on the moving unit 5. Therefore, the moving unit 5 slightly swings due to its own weight to be at a position where the locking claw 52 is locked to the locked portion 53. In this state, a contacting portion 57 of the moving unit 5 is slightly separated from a contacted portion 59 on the recording unit 33 side.

FIG. 13 illustrates a state in which the cover 4 is in the closed state and the swing lock mechanism 51 is in the locked state. In other words, FIG. 13 illustrates a state in which the moving unit 5 is pushed toward the recording unit 33 from the state illustrated in FIG. 12 to swing the swing lock mechanism 51 to a position to be in the locked state. In this state, the cover 4 is further changed from the open state to the closed state.

In the state illustrated in FIG. 13, since the pressing forces P1 and P2 of the first pressing portion 8 and the second pressing portion 10 act on the moving unit 5, the moving unit 5 further swings toward the recording unit 33 against its own weight. As a result of this swinging, the contacting portion 57 of the moving unit 5 is pressed against the contacted portion 59 on the recording unit 33 side, and the contacting portion 57 and the contacted portion 59 strongly come into contact with each other. The locking claw 52 is slightly separated from the locked portion 53. As a result, the moving unit 5 serving as the conveyance unit 34 and the recording unit 33 are separated from each other by an interval enabling recording on the medium by the recording unit 33. In other words, the distance between the moving unit 5 and the recording unit 33 achieved is a distance that provides a state in which the recording accuracy on the medium can be secured.

### Effects of Embodiment

(1) In the present embodiment, when the cover 4 is in the open state, as illustrated in FIGS. 14 and 16, the second pressing portion 10 protrudes beyond the first pressing portion 8. In other words, when the cover 4 pivots about the pivot shaft 3 serving as a fulcrum to transition from the closed state to the open state, the second pressing portion 10 positioned on the distal end portion 7 side of the cover 4 protrudes beyond the first pressing portion 8 positioned on the base end portion 6 side of the cover 4. Accordingly, when the cover 4 is opened, the opening amount of the cover 4 can be secured. At the same time, when the cover 4 is closed, the distal end of the first pressing portion 8 can be brought into contact with the cover 4, and the first pressing portion 8 can be reliably pushed in.

When the cover 4 is in the closed state, the pressing force P1 with which the moving unit 5 is pressed as a result of the first pressing portion 8 being biased by the first biasing member 9 is the same as the pressing force P2 with which the moving unit 5 is pressed as a result of the second pressing portion 10 being biased by the second biasing member 11 (P1=P2). Accordingly, when the cover 4 is closed, both sides of the moving unit 5 can be pressed with the same pressing forces P1, P2 by the first pressing portion 8 and by the second pressing portion 10. That is, the first pressing portion 8 and the second pressing portion 10 can uniformly press the moving unit 5 at two places on a side closer to and a side farther from the pivot shaft 3.

(2) In the present embodiment, the length L1 from the first restricted portion 16 provided to the first pressing portion 8 to the distal end 18 of the first pressing portion 8 is the same as the length L2 from the second restricted portion 17 provided to the second pressing portion 10 to the distal end 19 of the second pressing portion 10 (L1=L2). Further, the second restricting portion 15 provided to the second holder 13 is positioned downstream of the first restricting portion 14 provided to the first holder 12 in the protruding direction T. With this configuration, “the pressing force P1 of the first pressing portion 8 and the pressing force P2 of the second pressing portion 10 are the same” and “when the cover 4 is in the open state, the second pressing portion 10 protrudes beyond the first pressing portion 8” described above can be easily achieved with a simple structure. Therefore, the same effects as described above can be achieved.

In addition, by changing the position of the first restricting portion 14, it is possible to easily adjust the amount of protrusion of the first pressing portion 8 from the first holder 12. Similarly, by changing the position of the second restricting portion 15, it is possible to easily adjust the amount of protrusion of the second pressing portion 10 from the second holder 13.

(3) In the present embodiment, the first pressing portion 8 and the second pressing portion 10 are configured by the same components, and the first biasing member 9 and the second biasing member 11 are configured by the same components. With this configuration, the common use of the components facilitates the manufacture and reduces the cost.

(4) When the apparatus 1 with the cover is a structure using the positioning pin 23, frictional force may be generated between the cover 4 and the insertion opening 24 when the cover 4 is opened. However, in the present embodiment, even in such a structure, the cover 4 can be reliably opened.

(5) In a structure in which the positioning pin 23 and the insertion opening 24 are at opposite positions with respect to the pivot shaft 3, the distal end portion 7 side, that is, the free end side of the cover 4 tends to sag due to its own weight. In such a structure, in a state where the positioning pin 23 is inserted into the insertion opening 24 and positioned, about half of the weight of the cover 4 is applied to the positioning pin 23. Thus, frictional force is particularly likely to be generated between the positioning pin 23 and the insertion opening 24. However, according to the present embodiment, even in such a structure, the cover 4 can be reliably opened.

(6) In the present embodiment, when the lock mechanism 25 is in the unlocked state, the first pressing portion 8 and the second pressing portion 10 are biased by the first biasing member 9 and the second biasing member 11, respectively, and thus protrude. By the protrusion, the cover 4 pivots from the closed state to the open state. As a result, the cover 4 is automatically opened when the unlocked state is achieved, and thus the operability for the user can be improved.

(7) In the present embodiment, the amount of protrusion of the second pressing portion 10 from the second holder 13 is set to make the cover 4, when the unlocked state is achieved, pivot until the detected member 31 reaches a position not to be detected by the detection unit 32. With this configuration, when the unlocked state is achieved, the cover 4 overcomes the frictional force between the positioning pin 23 and the insertion opening 24 to open, and the open state can be sensed by the detection unit 32.

(8) In the present embodiment, when the apparatus 1 with the cover is the recording apparatus 100, it is possible to both stabilize an interval between the recording unit 33 and the conveyance unit 34 when the cover 4 is in the closed state and secure the opening amount of the cover 4 when the unlocked state is achieved.

### Other Embodiments

Although the apparatus 1 with a cover according to the present disclosure basically has the configuration of the embodiment described above, it is of course possible to change or omit partial configurations within a range not departing from the gist of the present disclosure.

In the above embodiment, a recording apparatus such as an ink-jet printer has been described as the apparatus 1 with the cover, but other printers may be used. That is, the present disclosure is also applicable to other apparatuses including the moving unit 5.

In addition, the moving unit 5 is not limited to the conveyance unit 34 in the embodiment and may be, for example, a recording unit or the like having a recording head.

The present disclosure can also be applied to an apparatus with a cover provided with no locking mechanism 25.

What is claimed is:

1. An apparatus with a cover, the apparatus comprising:
a housing;
the cover configured to be opened or closed, by pivoting about a pivot shaft with respect to the housing; and
a moving unit that is provided inside the housing, the moving unit being positioned at a first position when the cover is in a closed state, and being capable of moving to a second position different from the first position when the cover is in an open state, wherein
the cover has a base end portion on a side closer to the pivot shaft, and a distal end portion on a side farther from the pivot shaft, and includes
a first pressing portion that is provided at a position closer to the base end portion than to the distal end portion, and is configured to press the moving unit positioned at the first position,
a first biasing member configured to bias the first pressing portion toward the moving unit when the cover is in the closed state,
a second pressing portion that is provided at a position closer to the distal end portion than to the base end portion, and is configured to press the moving unit positioned at the first position, and
a second biasing member configured to bias the second pressing portion toward the moving unit when the cover is in the closed state,
when the cover is in the closed state, pressing force with which the moving unit is pressed as a result of the first pressing portion being biased by the first biasing member is the same as pressing force with which the moving unit is pressed as a result of the second pressing portion being biased by the second biasing member, and
when the cover is in the open state, the second pressing portion protrudes beyond the first pressing portion.

2. The apparatus with the cover according to claim 1, further comprising:
a first holder configured to hold the first pressing portion and the first biasing member;
a second holder configured to hold the second pressing portion and the second biasing member;
a first restricting portion provided to the first holder;
a second restricting portion provided to the second holder;
a first restricted portion provided to the first pressing portion; and
a second restricted portion provided to the second pressing portion, wherein
when the first restricted portion comes into contact with the first restricting portion while the cover is in the open state, movement of the first pressing portion in a protruding direction is restricted,
when the second restricted portion comes into contact with the second restricting portion while the cover is in the open state, movement of the second pressing portion in the protruding direction is restricted,
a length from the first restricted portion to a distal end of the first pressing portion and a length from the second restricted portion to a distal end of the second pressing portion are the same, and
the second restricting portion is positioned downstream of the first restricting portion in the protruding direction.

3. The apparatus with the cover according to claim 2, wherein
the first pressing portion and the second pressing portion are configured by the same components, and
the first biasing member and the second biasing member are configured by the same components.

4. The apparatus with the cover according to claim 1, further comprising:
a positioning pin configured to position the cover; and
an insertion opening into which the positioning pin is inserted when the cover is in the closed state.

5. The apparatus with the cover according to claim 4, wherein the positioning pin and the insertion opening are provided at opposite positions with respect to the pivot shaft.

6. The apparatus with the cover according to claim 1, further comprising a lock mechanism configured to lock the pivoting of the cover from the closed state to the open state, wherein
the lock mechanism includes
an engaged portion provided to the housing,
an engaging portion provided to the cover, and
an operation portion provided to the cover,
transition is achievable through an operation on the operation portion, between a locked state in which the pivoting of the cover is locked as a result of engagement between the engaging portion and the engaged portion, and an unlocked state in which the engagement between the engaging portion and the engaged portion is released, and
when the unlocked state is achieved, the cover pivots from the closed state to the open state, as a result of protrusion of the first pressing portion and the second pressing portion.

7. The apparatus with the cover according to claim 5, further comprising:
a detected member provided to the cover; and
a detection unit configured to detect the detected member to detect opening and closing of the cover, wherein
an amount of protrusion of the second pressing portion is set to make the cover pivot until the detected member reaches a position not to be detected by the detection unit when the unlocked state is achieved.

8. The apparatus with the cover according to claim 1, further comprising:
a recording unit configured to perform recording on a medium; and
a conveyance unit configured to convey the medium, wherein
the moving unit is the conveyance unit, and
the conveyance unit positioned at the first position faces the recording unit.
